(19) United States
(12) Patent Application Publication
(10) Pub. No.: US 2014/0278023 A1
(43) Pub. Date: Sep. 18, 2014

(54) METHOD FOR SUPPLYING A RAIL PRESSURE IN A COMMON RAIL SYSTEM

(71) Applicants: Markus ROESSLE, Stuttgart (DE); Helmar GRUHL, Steinheim An Der Murr (DE)

(72) Inventors: Markus ROESSLE, Stuttgart (DE); Helmar GRUHL, Steinheim An Der Murr (DE)

(73) Assignee: ROBERT BOSCH GMBH, Stuttgart (DE)

(21) Appl. No.: 14/205,034

(22) Filed: Mar. 11, 2014

(30) Foreign Application Priority Data
Mar. 12, 2013 (DE) 10 2013 204 230.2

(51) Int. Cl. F02D 41/06

(52) U.S. Cl. CPC F02D 41/065
USPC 701/113

(57) ABSTRACT

A method is described for supplying a rail pressure sufficient for a restart of a common rail internal combustion engine. The internal combustion engine is operated in a start/stop operation in which the internal combustion engine is stopped in response to a stop request and is started up again in response to a subsequent start request. The rail pressure is reduced by a presettable amount after a start request.

### FIELD OF THE INVENTION

The present invention relates to a method for supplying a rail pressure in a common rail system.

### BACKGROUND INFORMATION

Modern internal combustion engines are often equipped with a so-called automatic start/stop system. With such an automatic start/stop system, it is provided that the internal combustion engine is shut down automatically, depending on certain conditions. This usually occurs when the vehicle comes to a standstill. As soon as the driver wishes to drive on and indicates this by actuating an operating element such as the gas pedal or the clutch pedal, the internal combustion engine starts automatically. This is referred to as a restart within the context of the present invention.

If the rail pressure drops while the internal combustion engine is shut down in the case of an internal combustion engine equipped with such an automatic start/stop system, there may be a substantial delay in restarting the internal combustion engine under some circumstances. In addition, the hydraulic components are put under a heavy load.

It is provided that, with such start/stop systems, the idling pressure of approximately 300 bar, which is set before shutting down the engine, is to be maintained for as long as possible when the engine comes to a standstill. The goal here is for the rail pressure to be reliably higher than the pressure at which injection is enabled (usually approximately 120 bar) during a restart. Consequently, it is possible for a fuel injection to take place immediately during a restart without first having to build up a pressure in the rail and therefore losing starting time. This may be used to advantage in particular with systems in which the injector does not have any leakage gaps.

Therefore, German Published Patent Appln. No. 10 2008 007 668 describes a method for leaving the rail pressure at an idling setpoint pressure after shutting down the engine in order to accelerate the restart.

It is known that a pressure regulating valve may be used as part of a common rail system to maintain the rail pressure during operation of an internal combustion engine.

However, a certain minimum flow rate is necessary for regulating the rail pressure by using a pressure regulating valve. Regulation by a pressure regulating valve may therefore generally be considered only during engine operation.

To avoid an increased load or load cycle of the pressure regulating valve in vehicles having start/stop operation, a pressure regulating valve safety function may be implemented, causing the pressure regulating valve to be kept closed for a certain period of time during the stop phase. In common rail systems having little leakage, this results in maintaining the rail pressure over a certain period of time.

This pressure regulating valve safety function may thus be used (indirectly) to keep the rail pressure above the injection-enabling pressure point for a certain period of time during the stop phase in start/stop applications and to thereby ensure a rapid restart.

To ensure a rapid restart over a longer stop period, there have also been efforts to increase the rail pressure during shutdown of the engine. Reference may be made here to German Published Patent Appln. No. 10 2010 028 910, for example.

However, if a restart occurs very soon after a stop event, there is generally an elevated rail pressure. This may result in problems in conjunction with the pump load in a high-pressure pump used in a common rail system since the pump must start against the increased pressure. Furthermore, this may result in increased combustion noises since an injection occurs at a high pressure (e.g., >300 bar) and a low load (only self-acceleration of the engine to an idling speed).

An elevated rail pressure during a restart may also occur, for example, with common rail systems having a low tendency to leakage, merely on the basis of the reheating of the fuel used in the common rail system, which also results in the problems referenced above.

The goal of the present invention is therefore to prevent or at least minimize the problems mentioned above with respect to the pump load and combustion noise with a common rail system.

### SUMMARY

With the method according to the present invention, it is possible to ensure that the problems of pump load and combustion noises described above may be minimized or prevented entirely within the scope of a restart, while at the same time a rapid restart capability even after a lengthy stop time is made available. The reduction in the rail pressure by a predefinable amount according to the present invention after a start request makes it possible in particular to take into account how much time elapsed between a stop request and a subsequent start request. If only a short period of time has elapsed between these events, then it is generally advantageous to reduce the rail pressure by a greater amount. If a longer period of time has already elapsed, a smaller reduction may be adequate.

In addition to the possibility of reducing the rail pressure after a start request, which is provided according to the present invention, it is advantageous if there is also an increase in the rail pressure after a stop request. It is possible in this way to ensure that the rail pressure is always above an injection-enabling pressure during stop phases.

It is preferable in particular to carry out the reduction and/or the increase in rail pressure according to the present invention by controlling or regulating a pressure regulating valve. Such a pressure regulating valve, which is provided in traditional common rail systems, is easy to control to ensure the reduction or the increase in pressure according to the present invention.

The rail pressure is advantageously reduced before a start request if the prevailing rail pressure is above a presettable rail pressure threshold value. Such a rail pressure threshold value may be selected in particular as a function of a load-carrying capacity of the high-pressure pump used or of some other component of the common rail system. Conversely, this means that for the case when the rail pressure is below such a threshold value (but above the injection-enabling pressure) at the point in time of a start request, a further reduction in the rail pressure may be omitted.

It is advantageous in particular to reduce the rail pressure by taking into account measurable ambient parameters, in particular the prevailing rail pressure, temperature, etc.

A computation unit according to the present invention, for example, a control unit of a motor vehicle, is configured, in particular in the program technology, to carry out a method according to the present invention.

Implementation of the method in the form of software is also advantageous since this incurs particularly low costs, in particular when an executing control unit is used for additional tasks and therefore is available anyway. Suitable data media for supplying the computer program include in particular diskettes, hard drives, flash memories, EEPROMs, CD-ROMs, DVDs, etc. It is also possible to download a program via computer networks (Internet, Intranet, etc.).

Additional advantages and embodiments of the present invention are derived from the description and the accompanying drawing.

It is self-evident that the features mentioned above and those yet to be explained below may be used not only in the particular combination given but also in other combinations or alone without departing from the scope of the present invention.

The present invention is illustrated schematically in the drawing on the basis of one exemplary embodiment and is described in greater detail below with reference to the drawing.

### BRIEF DESCRIPTION OF THE DRAWINGS

FIG. 1 schematically shows a common rail system on the basis of which a preferred embodiment of a method according to the present invention is described.

FIG. 2 shows a diagram to further explain the present invention in that the rail pressure and the engine rotational speed are plotted as a function of time.

FIG. 3 shows a detail of the diagram according to FIG. 2 for the rail pressure.

### DETAILED DESCRIPTION

A typical common rail system is explained with reference to FIG. 1, which illustrates an injection system such as that which may form the basis of the present invention. FIG. 1 shows a schematic diagram of a common rail fuel injection system 100 for an internal combustion engine 116, for example, a diesel engine. A piston 126 is situated movably in a cylinder 124, cooled with cooling water 114, of internal combustion engine 116, shown here in a partially cutaway view. An injector 109 for injecting fuel into the cylinder is mounted on cylinder 124.

The fuel injection system includes a fuel tank 101, shown here almost full. Inside fuel tank 101 there is a pre-feed pump 103, which draws in fuel from a tank 101 through a prefilter 102 and delivers it through a fuel line 105 to a fuel filter 104 at a low pressure of 1 bar to maximal 10 bar. Another low-pressure line 105′ leads from fuel filter 104 to a high-pressure pump 106, which compresses the fuel drawn in to a high pressure, which is typically between 100 bar and 2000 bar, depending on the system. High-pressure pump 106 has a metering unit (ZME) 113 for adjusting a fuel quantity. High-pressure pump 106 supplies compressed fuel to a high-pressure line 107 and a rail 108, the so-called common rail, connected to the former. Another high-pressure line 107′ leads from rail 108 to injector 109.

A system of return lines 110 permits the return flow of excess fuel out of fuel filter 104, high-pressure pump 106 and metering unit 113, injector 109 and rail 108 into fuel tank 101. A pressure regulating valve (DRV) 112 is connected between rail 108 and return line 110 which regulates the high pressure, the so-called rail pressure, prevailing in rail 108 to a constant value by varying the fuel quantity flowing out of rail 108 into return line 110.

Entire common rail injection system 100 is controlled by a control unit 111, which is connected via electric lines 128 to pre-feed pump 103, high-pressure pump 106, metering unit 113, injector 109, a pressure sensor 134 on rail 108, pressure regulating valve 112 and temperature sensors 132, 122 on internal combustion engine 116 or on fuel inlet line 105. Control unit 111 is connected via a bus system 136 to additional control units (not shown) with the aid of which it has access to additional data such as the ambient temperature, the driving speed or the engine rotational speed. In addition, an automatic start/stop system (control) 150 is provided which provides a signal S. This start/stop control is designed in such a way that it shuts down the internal combustion engine under certain conditions. For example, the internal combustion engine is shut down when the start/stop control detects that the vehicle has stopped. If the start/stop control detects that the driver wishes to continue driving, then the start/stop control starts the internal combustion engine and enables continued driving.

The rail pressure may be reduced to an optimal extent after a start request by triggering the pressure regulating valve. This reduction advantageously takes place until the startup of the pump or a first injection.

The following adjustments of a common rail system are advantageous in this regard in comparison with traditional systems:

On the hardware side, pressure regulating valve 112 is advantageously designed to also carry out a sufficiently accurate regulation of the rail pressure in the available time at even very low flow rates.

For this purpose, the pressure regulating valve advantageously has at least one of the following structural features: the entire valve actuator system is not designed to be too large to be able to implement the required dynamics of the rail pressure regulation. A short reaction time of the valve actuator system is to be noted in particular, a rapid response of the solenoid circuit being of great importance. In this context, the use of proportional valves, with which the trigger signal is proportional to the resulting rail pressure, is preferred in particular.

A flow rate of 0.1 to 1.5 cubic centimeters should preferably be achievable in 50 ms to 100 ms.

On the software side, a corresponding regulating algorithm which is capable of triggering the pressure regulating valve accordingly to carry out the desired rail pressure adjustment, i.e., rail pressure reduction, must be implemented in engine control unit 111 assigned to the common rail system. This regulating algorithm may advantageously also be capable of triggering a rail pressure increase as needed.

The controlled system including a sensor system, engine control unit 111, an actuator system and a regulating algorithm must be capable of establishing the desired rail pressure within a very short time range (50 ms to 100 ms). Vibrations are to be prevented here; this is implementable by a moderate adjustment in the setpoint input, if necessary (in comparison with the conventional regulating behavior of a pressure regulating valve). Overshooting in the control, resulting in the rail pressure being reduced beyond the desired extent, is completely preventable according to the present invention since a pressure buildup during a shutdown of the internal combustion engine and the mechanical coupling of the high-pressure pump to the internal combustion engine is not possible.

It is advantageous that, according to the present invention, the entire tolerance chain of the controlled system, including the sensor system, engine control unit 111 and actuator system is taken into account, which may result in a deviating pressure regulating valve behavior. The sensors required for the regulating algorithm for detection of the rail pressure, for example, or other parameters are already provided in vehicles today and in common rail systems. During shutdown phases, it is also advantageous that the computation capacity required for rapid regulation is readily available in the control unit.

Corresponding characteristics maps with respect to suitable rail pressures are advantageously available in control unit 111 as a function of various ambient parameters (rail pressure, temperature, etc., for example).

FIG. 2 shows a preferred specific embodiment of the method according to the present invention on the basis of a rail pressure/time diagram. A preferred curve 210 of rail pressure p and corresponding engine rotational speed n are plotted as a function of time in this diagram (curve 220).

In this diagram, the injection-enabling pressure, i.e., the minimum pressure to be supplied for a successful injection, is labeled as p₀. Injection-enabling pressure p₀ is 100 bar, for example. It is preferable for the rail pressure during operation of the common rail system to be kept at a working pressure p_{A} slightly above the injection pressure, if possible.

After a stop request at a point in time t₀, the rail pressure, which is greater than p₀ at point in time t₀, is initially increased in rail 108. The increase in pressure may occur in particular by setting high-pressure pump 106 at full delivery, opening metering unit 113 completely and closing pressure regulating valve 112 completely. In this way, the rail pressure is increased to a first setpoint pressure p₁ at a point in time t₁. Starting from this pressure p₁, the rail pressure then drops slowly, for example, to a pressure p₂ at a point in time t₂.

According to the present invention, it is now provided that in a startup request at this point in time t₂, the rail pressure is lowered, i.e., reduced to a second setpoint pressure p₃. This pressure p₃ is reached at a third point in time t₃. This pressure p₃ is preferably slightly above injection-enabling pressure p₀. Pressure p₃ may correspond to working pressure p_{A}, for example. This pressure reduction ensures that the rail pressure is set optimally for largely preventing combustion noise and for minimizing the loads on pressure regulating valve 112 and high-pressure pump 106.

After the stop request at point in time t₀, engine rotational speed n drops to a value of n=0 from a value n_{A}, which corresponds to an idling rotational speed, for example, at a point in time t₂ (or even earlier). After the start request at point in time t₂, engine rotational speed n may increase back to value n_{A} or another appropriate value without any time lag, starting at point in time t₃, for example, when the rail pressure corresponds to setpoint pressure p₃ in the common rail system, since at least injection-enabling pressure pₒ always prevails in the common rail system. The overall delay to be observed between the start request and the increase in engine rotational speed is minimal or is even zero and in any case is not noticeable for a user or a driver of a motor vehicle.

FIG. 3 shows more precisely the range of the diagram according to FIG. 2 between the start request at point in time t₂ and reaching setpoint pressure p₃ at point in time t₃; a pressure curve 310b, which is acceptable in practice, is also shown next to an ideal pressure curve 310a.

An ideal or desired rail pressure curve is labeled as 310a. This illustrates an essentially continuous or uniform drop in pressure between pressure values p_{2′}, and p₃. This rail pressure curve 310a may be achieved, for example, when the triggering of pressure regulating valve 112 causes a uniform opening of this pressure regulating valve over time.

In reality, however, there is often a so-called slip-stick effect, in which continuous triggering of the pressure regulating valve does not result directly in a continuous opening behavior. For example, in the triggering of pressure regulating valve 112, there may initially be no change at all in the rail pressure since the pressure regulating valve does not open initially. However, with a further increase in the trigger signal, there is then a sudden opening of the pressure regulating valve and thus a sudden change in the rail pressure accordingly, so that overshooting may also occur.

To prevent this effect, the use of an adaptive regulation is proposed to adjust an actual rail pressure curve as closely as possible to a rail pressure curve according to 310a. This is achievable, for example, by the fact that initially a moderate adjustment of the rail pressure setpoint value is formulated in comparison with a conventional regulation of the pressure regulating valve. Such a delay in the setpoint adjustment in comparison with traditional methods for regulating the pressure regulating valve results in a slight delay in valve opening. Such an acceptable rail pressure curve is labeled as 310b.

Shortly before reaching setpoint pressure p₃, a corresponding acceleration of the setpoint value adjustment (faster regulation) may then be carried out. As a result, a regulating behavior, which is largely in accordance with the ideal rail pressure curve 310a, may be made available, so that overshooting in particular may be avoided.

Finally, it should be pointed out that for the case when the rail pressure is below an additional threshold value p₄ at the point in time of a start request, a reduction in the rail pressure according to the present invention may be omitted. This variant is not shown in the figures. FIG. 2 shows only one such threshold value p₄ merely for the sake of clarity. In this case, there may also be an increase in engine rotational speed n and a start request without any delay.

What is claimed is:

1. A method for supplying a rail pressure sufficient for a restart of a common rail internal combustion engine, comprising:
operating the internal combustion engine in a start/stop operation, in which the internal combustion engine is stopped in response to a stop request and is started up again in response to a subsequent start request; and
after a start request, reducing the rail pressure by a presettable amount.

2. The method as recited in claim 1, further comprising:
after the stop request, increasing the rail pressure by the presettable amount by supplying a fuel.

3. The method as recited in claim 2, wherein at least one of the reduction and the increase in the rail pressure is achieved by one of triggering and regulating a pressure regulating valve.

4. The method as recited in claim 1, wherein the reduction in the rail pressure occurs after the start request when a prevailing rail pressure is above a rail pressure threshold value.

5. The method as recited in claim 1, wherein the reduction in the rail pressure occurs by taking into account a measurable ambient parameter.

6. The method as recited in claim 5, wherein the measurable ambient parameter includes at least one of a prevailing rail pressure and a prevailing temperature.

7. A computation unit containing program code that when executed results in a performance of a method for supplying a rail pressure sufficient for a restart of a common rail internal combustion engine, the method comprising:
operating the internal combustion engine in a start/stop operation, in which the internal combustion engine is stopped in response to a stop request and is started up again in response to a subsequent start request; and
after the start request, reducing the rail pressure by a presettable amount, which is configured to carry out a method as recited in one of the preceding claims.
